(19) United States
(12) Patent Application Publication
(10) Pub. No.: US 2009/0074315 A1
(43) Pub. Date: Mar. 19, 2009

(54) METHOD OF IMAGE COMPRESSION AND DEVICE THEREOF

(75) Inventor: Sheng-Chun Niu, Tainan County (TW)

Correspondence Address: J C PATENTS, INC., 4 VENTURE, SUITE 250, IRVINE, CA, 92618, US

(73) Assignee: HIMAX TECHNOLOGIES LIMITED, Tainan County (TW)

(21) Appl. No.: 11/857,600

(22) Filed: Sep. 19, 2007

(51) Int. Cl. G06K 9/36

(52) U.S. Cl. 382/251

(57) ABSTRACT

A method of image compression and a device thereof are provided herein. First, an image having a plurality of regions is received. Next, a quantization process is performed on a specific region of the image according to a quantization value, wherein the specific region is one of the regions. Next, a first average bit rate of the specific region of the image after an encoding process is calculated. Furthermore, the quantization value of the corresponding specific region of the next received image is adjusted according to the first average bit rate of the specific region of the image. Therefore, by referring to the scene complexity of the previous image to adjust the quantization value, the compressed image quality can be enhanced and the compression ratio can be maintained a regular value without wasting bandwidth.

### BACKGROUND OF THE INVENTION

1. Field of the Invention

The present invention relates to a method of image compression and a device thereof, and more particularly, to dynamically adjust a quantization value according to the information of the previous image.

2. Description of Related Art

Image compression means to reduce a data size of a digital image to a level that can be supported by storage or transmission medium. Data are the carriers transmitting information, and the equal amount of information can be represented by different data size. For example, if a story is said by different persons, amount of the language used by different persons for describing the same story are quite different, wherein the information interested in is the story and the data representing the information is the language. The data providing the information unconcerned with or the known information repeatedly said are called the data redundancy. The data redundancy can be quantitatively determined in mathematics, such as Rd=1−1/Cr, wherein Rd is the data redundancy and Cr is the compression ratio.

The compression ratio Cr equals N1/N2, wherein N1 and N2 are the data size before and after image compression, respectively. The compression ratio Cr is used instead of bit rate to characterize the capability of the compression system. As for lossy compression, the compression ratio Cr getting higher means the data redundancy is highly eliminated, but in the other hand, the distortion of the compressed image also gets higher. In order to make balance between eliminating the data redundancy and reducing the distortion of the compressed image, the compression ratio Cr needs to be well controlled.

FIG. 1 is a diagram of conventional model of the image compression. Referring to FIG. 1, based on a presetting fidelity criterion, an image is quantized by the quantizer 110 according to a quantization parameter QP. Because human eyes have unequal sensitivity to all the visual information, such as human eyes is more sensitive on the flat region than on the edges of the image, the quantizer 110 is used to reduce the psycho-visually redundant information which are not important when comparing to a normal visual processing. The encoder 120 performs a variable-length coding on the image, which the encoder 120 utilizes less bit number to code the gray levels having higher appearance probability than to code those having less appearance probability for reducing the coding redundancy.

The quantization parameter QP is extremely related to the compression ratio Cr. In the past, the image is compressed by a fixed compression ratio Cr. For an instance of the image having 240×320 pixels, if each pixel has components of three primary colors of light called red, green and blue, and eight bits is used to represent each primary color, the total bits of the image are 240×320×3×8. For the fixed compression ratio Cr=2, the total bits of the compressed image are (240×320×3×8)/2 and the average bit rate equals twelve. Therefore, a rate control process is needed for adjusting the quantization parameter QP according to the average bit rate of the compressed image and maintaining the fixed compression ration Cr.

Besides, the scene complexity is non-uniform distributed in the image. scene complexity of the previous image. Therefore, not only the compression ratio of the image can be controlled within the proper range, but also the bandwidth of the transmission medium can be efficiently utilized to enhance the image quality. The device of image compression is carried out according to this method.

A method of image compression is provided in the present invention. First, an image having a plurality of regions is received and a quantization process is performed on a specific region which is one of the regions according to a quantization value. Next, a first average bit rate of the specific region of the image after an encoding process is calculated. Next, the quantization value of the corresponding specific region of the next received image is adjusted according to the first average bit rate of the specific region of the image.

A device of image compression comprising a receiver module, a quantization module, an encode module and a control module is provided in the present invention. The receiver module is used for receiving an image having a plurality of regions. The quantization module is coupled to the receiver module and is used for performing a quantization process on a specific region of the image according to a quantization value, wherein the specific region is one of the regions. The encode module is coupled to the quantization module and is used for performing an encoding process on the specific region of the image. The control module is coupled to the encode module and is used for calculating a first average bit rate of the specific region of the image after the encoding process and adjusting the quantization value of the corresponding specific region of the next received image according to the first average bit rate of the specific region of the image.

The present invention provides a method of image compression and a When the scene complexity of the image is low, the encoding process comprising quantizing and coding can almost be seen as lossless compression and the compression ratio Cr does not decrease. On the contrary, when the scene complexity of the image is high, in order to controlling the compression ratio Cr to be fixed, the distortion of the compressed image needs to increase to exchange for less bit number. For this reason, the image quality and the compression ratio Cr can not be given consideration simultaneously.

Furthermore, for a whole image, the compression order of the image is from top to bottom. When a location of the image is encoded presently, the information having been encoded can be realized, but the information having not been encoded yet can not be predicted. Therefore, if the scene complexity of the upper part in the image is higher and the scene complexity of the under part in the image is lower, the distortion of the upper part increases for maintaining the compression ratio Cr of the upper part not to decrease. Due to the scene complexity of the under part in the image can not be predicted, the under part may be quantized according to the same quantization parameter QP and then the compression ratio Cr of the under part increases. When the compression ratio Cr is higher than a presetting value, the redundant bandwidth can not be efficiently utilized to decreases the distortion and to enhance the peak signal-to-noise ratio (PSNR) of the upper part.

### SUMMARY OF THE INVENTION

Accordingly, the present invention provides a method of image compression and a device thereof. Because the continuous images have correlation mutually, the quantization value for quantizing is dynamically adjusted according to the scene thereof which dynamically adjust the quantization value of one region of the next received image for quantizing according to the first average bit rate of the corresponding one region of the previously compressed image, wherein the first average can respond to the scene complexity of the image. Because continuous images often have high correlation mutually, by this way of adjusting the quantization value, the present invention can make the bandwidth being utilized efficiently and decrease the distortion degree of the compressed image according to its scene complexity.

In order to make the features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of conventional model of the image compression.

FIG. 2 is a block diagram of image compression device according to one embodiment of the present invention.

FIG. 3A is a diagram of the compressed image according to the of the present invention.

FIG. 3B is diagram of the next compressed image according to the embodiment of the present invention.

FIG. 4 is a flow chart of image compression method of one embodiment of the present invention.

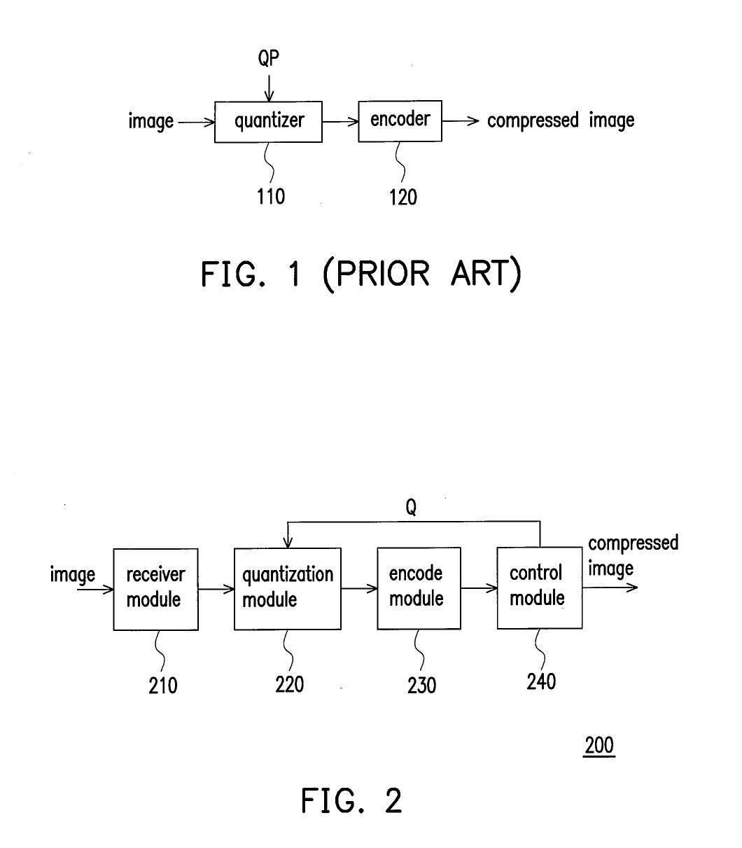

### DESCRIPTION OF EMBODIMENTS

In one embodiment of the present invention, a scene complexity of an image is recorded to improve the encoding manner of the next image and to reduce the distortion degree of the next image.

FIG. 2 is a block diagram of image compression device according to one embodiment of the present invention. Referring to FIG. 2, the image compression device 200 comprises a receiver module 210, a quantization module 220, an encode module 230 and a control module 240. The receiver module 210 receives an image, wherein the image has a plurality of regions. The quantization module 220 is coupled to the receiver module 210 and performs a quantization process on a specific region of the image according to a quantization value Q, wherein the specific region is one of the regions. The encode module 230 is coupled to the quantization module 220 and performs an encoding process on the specific region of the image. The control module 240 is coupled to the encode module 230 and is used for calculating a first average bit rate of the specific region of the image after the encoding process and then adjusting the quantization value Q of the corresponding specific region of the next received image according to the first average bit rate of the specific region of the image. What follows is the function description of each module.

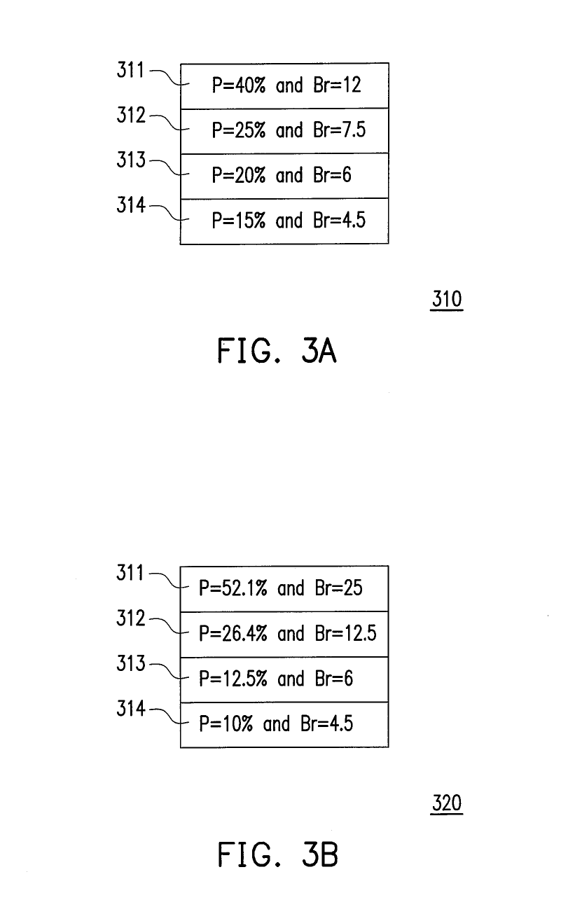

FIG. 3A is a diagram of the compressed image 310 according to the embodiment of the present invention. The image is supposed having four regions and those regions are respectively region 311˜314 for the convenience of describing. Referring to FIG. 2 and FIG. 3A, when the image is received, the quantization module 220 performs the quantization process, such as a differential pulse code modulation (DPCM), on the received image from region 311 to region 314. People ordinary skilled in the art has known very well about the DPCM and there is no need to give unnecessary details. During the quantization process, the quantization module 220 utilizes the quantization value Q to quantize a specific region, such as region 311. In the embodiment, the quantization value Q is related to the step size for quantizing so that the quantization value Q gets higher and the distortion of the compressed image 310 also gets higher.

After the quantization process, the encode module 230 performs the encoding process, such as a variable length coding (VLC), on the specific region of the image. Then, after the encoding process, the control module 240 calculates the first average bit rate Br of the specific region of the compressed image 310. The first average bit rate Br can respond to the scene complexity of the specific region of the image. Referring to FIG. 3A, a bit number percentage P of the regions 311˜314 are respectively 40%, 25%, 20% and 15%, and the first average bit rate Br of the region 311˜314 are respectively 12, 7.5, 6 and 4.5 bit/second, wherein the bit number percentage P is the bit number of each region over the total bit number of the compressed image 310. The higher first average bit rate Br of the specific region, such as region 311, means high frequency component existing in the specific region and also means the scene complexity of the specific region is higher. On the contrary, the lower first average bit rate Br of the specific region, such as region 314, represents the scene complexity of the specific region is lower.

If each pixel of the received image has three color components and eight bits is used to represent each color component, for a compression ratio equaling two, a second average bit rate of the compressed image should be twelve. Referring to FIG. 3A, the second average bit rate of the compressed image 310 is (12+7.5+6+4.5)/4=7.5 bit/second, and apparently, the bandwidth can not be efficiently utilize. Therefore, the control module 240 adjusts the quantization value Q of the corresponding specific region of the next received image according to the first average bit rate Br of the specific region of the compressed image 310.

FIG. 3B is a diagram of the next compressed image 320 according to the embodiment of the present invention. Referring to FIG. 2, FIG. 3A and FIG. 3B, for taking region 311 being the specific region as an example, the control module 240 has obtained the first average bit rate Br=12 bit/second of the region 311 of the compressed image 310, and for efficiently utilizing the redundant bandwidth, the control module 240 determines that the quantization value Q of the corresponding region 311 of the next received image needs to be adjusted lower for decreasing the distortion of the corresponding region 311 of the next compressed image 320. As shown in FIG. 3B, the bit number percentage P of the corresponding region 311 of the next compressed image 320 increases to 52.1% and the first average bit rate Br also increases to 25 bit/second. Simply speaking, under the allowable bandwidth, the control module 240 utilizes more bit number to exchange for lower distortion of the corresponding region 311 of the compressed image 320.

To reason by analogy, the control module 240 also adjusts the quantization value Q of the corresponding region 312 of the next received image to be lower so that the bit number percentage P and the first average bit rate Br of the corresponding region 312 of the next compressed image 320 respectively increases to 26.4% and 12.5 bit/second. Due to the lower scene complexity of the regions 313 and 314 of the compressed image 310, the control module 240 may adjust the quantization value Q of the regions 313 and 314 of the next received image to be higher or does not adjusts them. Therefore, the bit number percentage P and the first average bit rate Br of the corresponding region 313 of the next compressed image 320 are respectively 12.5% and 6 bit/second, and the bit number percentage P and the first average bit rate Br of the corresponding region 314 of the next compressed image 320 are respectively 10% and 4.5 bit/second.

Referring to FIG. 3B, as the description of the embodiment, the control module 240 can controls the second average bit rate of the next compressed image to be within a predetermined value, such as (25+12.5+6+4.5)=12 bit/second which is the desired goal of setting the compression ratio to equal two. By this way of dynamically adjusting the quantization values Q, not only the compression ratio of the image (or the second average bit rate of the image) can be maintained, but also the bandwidth can be efficiently utilized for decreasing the distortion of the image and enhancing the quality of the compressed image.

It is note that the number and size of the regions should not be limited and people ordinary skilled in the art can apply any compression standards into the image compression device of the embodiment, such as standard of Joint Photographic Experts Group (JPEG) or H.26X video compression standard provided from International Telecommunication Union (ITU-T) etc, according to the teaching of the embodiment of the present invention. For example, the image compression of JPEG is based on block with 8×8 pixels so that the regions can be any size of blocks forming the image. Besides, the quantization value Q in the embodiment of the present invention is supposed relating to the step size for quantizing, but in another embodiment of the invention, the quantization value Q relates to the step number for quantizing so that the higher the quantization value Q is, the lower distortion of the compressed image is.

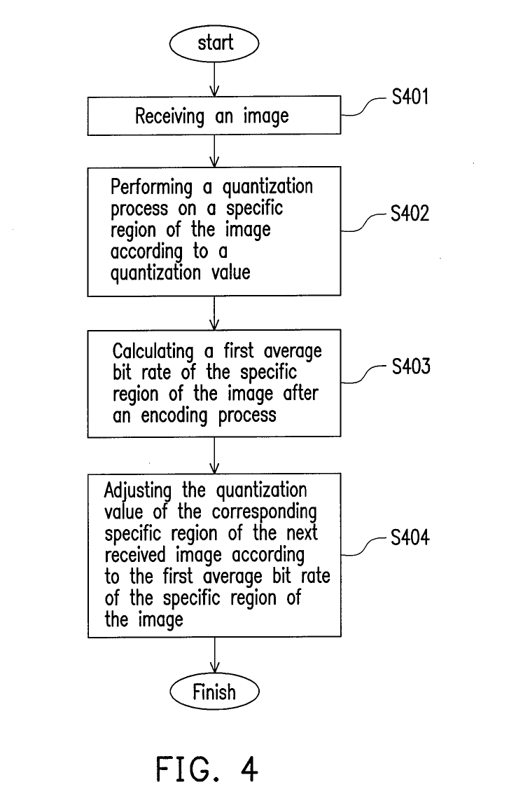

According to the embodiment described above, the steps of the following method could be generalized. FIG. 4 is a flow chart of image compression method of one embodiment of the present invention. Referring to FIG. 4, first of all, in step S401, an image is received, wherein the image has a plurality of regions. The following step S402, a quantization process is performed on a specific region of the image according to a quantization value, wherein the specific region is one of the regions. Next, a first average bit rate of the specific region of the image after an encoding process is calculated in the step S403. In the step S404, the quantization value of the corresponding specific region of the next received image is adjusted according to the first average bit rate of the specific region of the image. Therefore, the next received image is compressed by the quantization value relating to the scene complexity of previous compressed image and the distortion of the next compressed image can also be well controlled within an allowable bandwidth and a regular compression ratio.

In summary, the embodiment of the present invention provides a method of image compression and a device thereof which dynamically adjust the quantization value according to the scene complexity of the previous image. When an image having a plurality of regions is compressed, the first average bit rate of one region of the compressed image can respond to the scene complexity of the one region and the second average bit rate of the compressed image can be applied to control the compression ratio. The embodiment of the present invention utilizes the first average bit rate of the one region of the compressed image to adjust the quantization value of the corresponding one region of the next received image and controls the second average bit rate within a predetermined value for maintaining a regular compression ratio. Hence, under the regular compression ratio, the quantization value is dynamically adjusted to enhance the quality of the compressed image and to efficiently utilize the bandwidth.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. A method of image compression, comprising:
receiving an image, wherein the image has a plurality of regions;
performing a quantization process on a specific region of the image according to a quantization value, wherein the specific region is one of the regions;
calculating a first average bit rate of the specific region of the image after an encoding process; and
adjusting the quantization value of the corresponding specific region of the next received image according to the first average bit rate of the specific region of the image.

2. The method of image compression as claimed in claim 1, further comprising:
controlling a second average bit rate of the image to be within a predetermined value.

3. The method of image compression as claimed in claim 1, wherein the step of adjusting the quantization value of the corresponding specific region of the next received image according to the first average bit rate of the specific region of the image comprises:
adjusting the quantization value of the corresponding specific region of the next received image to be smaller when the first average bit rate of the specific region of the image is higher; and
adjusting the quantization value of the corresponding specific region of the next received image to be higher when the first average bit rate of the specific region of the image is smaller.

4. The method of image compression as claimed in claim 1, wherein the encoding process is the process of variable length coding.

5. A device of image compression, comprising:
a receiver module, for receiving an image, wherein the image has a plurality of regions;
a quantization module, coupled to the receiver module for performing a quantization process on a specific region of the image according a quantization value, wherein the specific region is one of the regions;
an encode module, coupled to the quantization module for performing an encoding process on the specific region of the image; and
a control module, coupled to the encode module for calculating a first average bit rate of the specific region of the image after the encoding process and adjusting the quantization value of the corresponding specific region of the next received image according to the first average bit rate of the specific region of the image.

6. The device of image compression as claimed in claim 5, wherein the control module further controls a second average bit rate of the image to be within a predetermined value.

7. The device of image compression as claimed in claim 5, wherein the control module adjusts the quantization value of the corresponding specific region of the next received image to be smaller when the first average bit rate of the specific region of the image is higher and adjusts the quantization value of the corresponding specific region of the next received image to be higher when the first average bit rate of the specific region of the image is smaller.

8. The device of image compression as claimed in claim 5, wherein the encoding process is the process of variable length coding.
